(19) United States
(12) Patent Application Publication
(10) Pub. No.: US 2011/0269585 A1
(43) Pub. Date: Nov. 3, 2011

(54) TENSION REGULATOR WITH A PRESSURE VESSEL APPLIED TO A TIMING BELT

(75) Inventor: GUAN-REN WANG, KAOHSIUNG COUNTY (TW)

(73) Assignee: GONG SHUN TECHNOLOGY CO., LTD., KAOHSIUNG COUNTY (TW)

(21) Appl. No.: 12/772,348

(22) Filed: May 3, 2010

(51) Int. Cl. F16H 7/08

(52) U.S. Cl. 474/110

(57) ABSTRACT

A tension regulator with a pressure vessel applied to a timing belt installs a pressure vessel between a body and a propelling device. By means of a moving space being defined in the pressure vessel, the propelling device could be accommodated and moved therein. Accordingly, the hydraulic oil would not readily escape from the body, and a using safety could be assured.

### BACKGROUND OF THE INVENTION

1. Field of the Invention

The present invention relates to a tension regulator, particularly to a tension regulator with a pressure vessel applied to a timing belt.

2. Description of the Related Art

Referring to FIGS. 1 and 2, a conventional tension regulator 1 applied to a timing belt comprises a body 11, a propelling device 12 disposed in the body 11, and a blocking device 13 disposed for sealing the body 11 as well as blocking the propelling device 12. Wherein, the body 11 has a sliding space 111 defined therein for hydraulic oil 14 to fill, and an opening 112 formed on the body 11 for the sliding space 111 to communicate with an exterior therethrough. Moreover, the propelling device 12 has an elastic member 121 elongated into the sliding space 111, and a propelling member 122 stretched within the sliding space 111 for being propelled by the elastic member 121.

Referring to FIG. 2, a timing belt (not shown) is propelled by the tension regulator 1; that is, the propelling member 122 is driven by the elasticity of the elastic member 121, so that a part of the propelling member 122 protruded out of the blocking device 13 is able to thrust the timing belt with proper pressure via a belt idler (not shown). Afterward, the propelling member 122 would retract to engage with the elastic member 121 in accordance with the tense state of the timing belt, so that the propelling member 122 propelled by the belt idler and the timing belt could properly resume the action for a next thrust.

However, the conventional tension regulator 1 has the following shortcomings:
1. The manufacturing of the body 11 of the tension regulator 1 generally involves a die-casting formation means. However, the die-cast product substantially possesses the lower density than that of the alloy in view of their different forming manners. Herein, there are tiny interstices facilely formed on the die-cast product. Especially, if the body 11 is made of the aluminum alloy, more tiny interstices will be formed. Wherein, because of the adverse interstices, the hydraulic oil 14 sealed in the body 11 readily leaks out either in time of the propelling device 12 being motivated or even under a motionless condition. As time passes, the leakage of the hydraulic oil 14 thence incurs an insufficient oil amount, and the operation of the propelling device 12 could not be precisely achieved.
2. The leakage of the hydraulic oil 14 incurring the insufficient oil amount is unable to be refilled, thereby resulting in a short lifespan of the tension regulator 1. Thus, such tension regulator 1 has to be replaced regularly, or the driving safety would be influenced. Herein, if users insist on refilling the hydraulic oil 14, they have to firstly remove the blocking device 13. As to sealing the hydraulic oil 14 with the blocking device 13, a professional machine should be applied for achieving the operation. Obviously, such procedure and fabrication involve a complicated and professional technology; ordinary users are unable to readily execute the operation by themselves.

### SUMMARY OF THE INVENTION

The object of the present invention is to provide a tension regulator with a pressure vessel applied to a timing belt, which effectively prevents the hydraulic oil from leakage so as to promote the using safety.

The tension regulator with a pressure vessel applied to a timing belt in accordance with the present invention comprises a body, a propelling device disposed in the body, and a blocking device disposed for sealing the body as well as limiting the propelling device in the body. Wherein, a pressure vessel installed between the body and the propelling device includes a moving space enveloped by a circumferential wall and a bottom wall. Moreover, the pressure vessel further defines a second opening opposite to the bottom wall, thereby allowing the moving space to communicate with an exterior via the second opening. Whereby, the propelling device is set and moved within the moving space, and the hydraulic oil fills the moving space. Consequently, the pressure vessel effectively averts the hydraulic oil from leakage, and the using safety is assured.

In this connection, the tension regulator with a pressure vessel applied to a timing belt as claimed includes a body filled with hydraulic oil, a propelling device installed in the body, and a blocking device disposed for sealing the body and limiting the propelling device in the body. Wherein, the body includes a sliding space one side thereof that is communicated with an exterior via a first opening defined thereon. The first opening is sealed by the blocking device. The propelling device has an elastic member and a propelling member driven by the elastic member. A part of the propelling member is protruded out of the blocking device. Particularly, a pressure vessel is mounted between the body and the propelling device and comprised of a moving space enveloped by a circumferential wall and a bottom wall. The pressure vessel further forms a second opening opposite to the bottom wall, thereby permitting the moving space to communicate with the exterior via the second opening. Moreover, the moving space filled up with the hydraulic oil is defined for the propelling device to be accommodated and moved therein.

Preferably, the bottom wall of the pressure vessel further defines a filling hole that penetrates through the body and communicates with the exterior, and a sealing member is disposed on the filling hole for executing the sealing.

The advantages of the present invention over the known prior arts will become more apparent to those of ordinary skilled in the art upon reading the following descriptions in junction with the accompanying drawings.

### BRIEF DESCRIPTION OF THE DRAWINGS

FIG. 1 is a schematic view showing a conventional tension regulator;

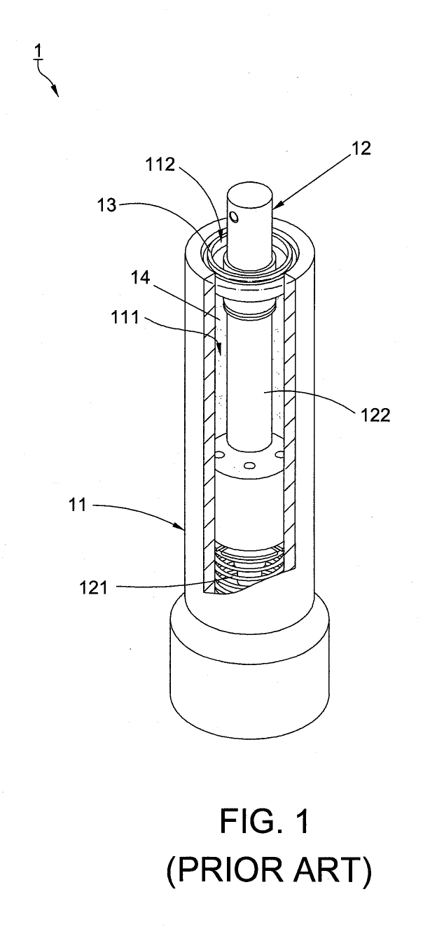

FIG. 2 is a schematic view showing the conventional tension regulator in using;

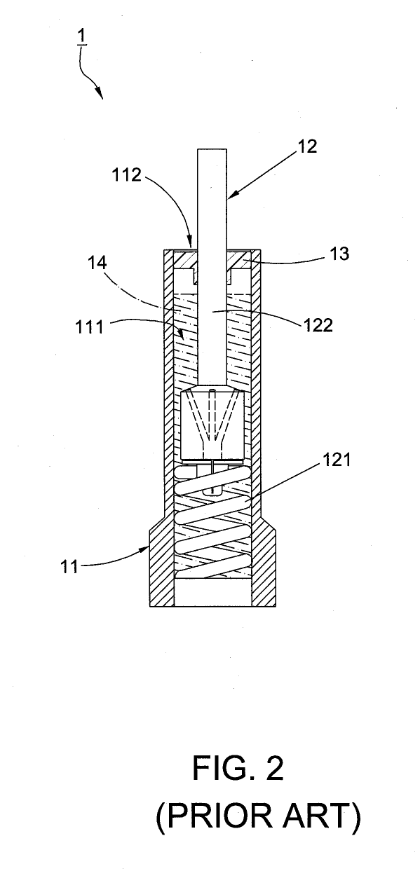

FIG. 3 is a perspective view showing a first preferred embodiment of the present invention;

FIG. 4 is a cross-sectional view of the first preferred embodiment; and

FIG. 5 is a schematic view showing a second preferred embodiment of the present invention.

### DETAILED DESCRIPTION OF THE PREFERRED EMBODIMENTS

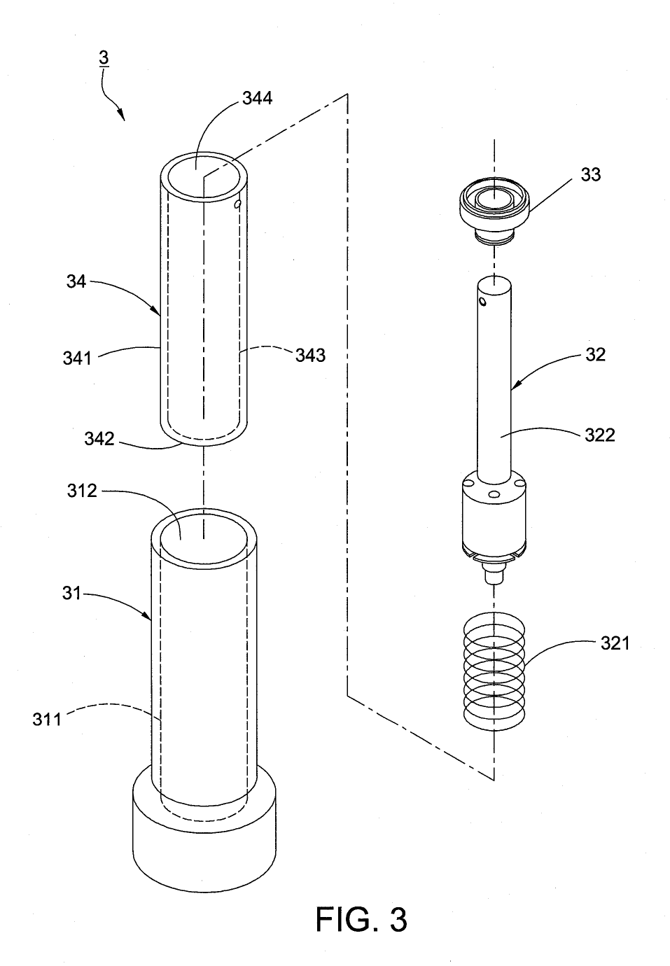

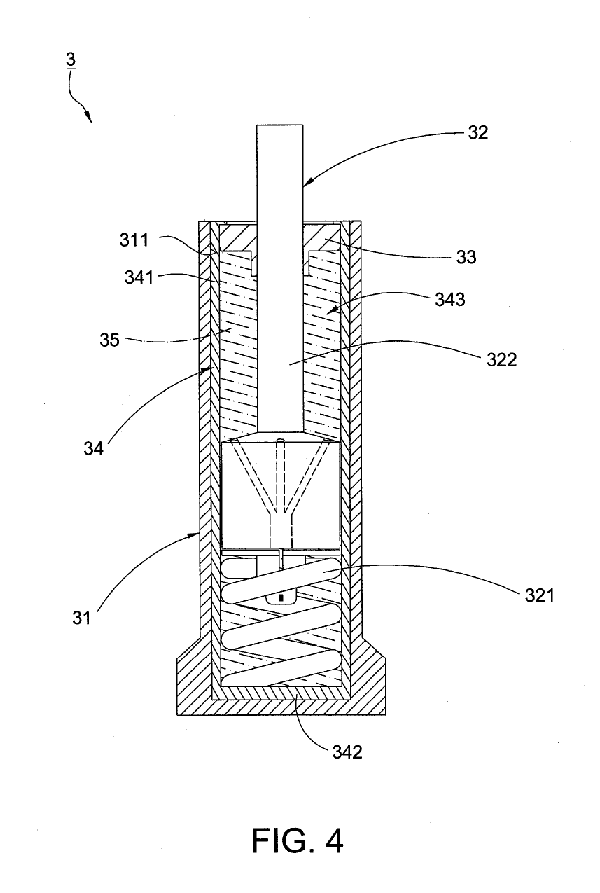

FIGS. 3 and 4 show a first preferred embodiment of the present invention, a tension regulator 3 comprising a body 31, a propelling device 32 installed inside the body 31, and a blocking device 33 disposed for sealing the body 31 and limiting the propelling device 32 in the body 31. Wherein, the body 31 defines a sliding space 311, of which one side communicates with an exterior via a first opening 312 defined on the body 31. Herein, the first opening 312 could be sealed by the blocking device 33.

A pressure vessel 34 disposed between the body 31 and the propelling device 32 has a moving space 343 enveloped by a circumferential wall 341 and a bottom wall 342. Wherein, the pressure vessel 34 is preferably formed into a seamless status, for example, the circumferential wall 341 and the bottom wall 342 of the pressure vessel 34 could be made by a plastic or an alloy plate subjected to a bend formation. Alternatively, directly processing the alloy steel to form the pressure vessel 34 is also available. In this embodiment, the pressure vessel 34 is made of the alloy steel and adopts the direct process formation. Further, the pressure vessel 34 correspondingly forms a second opening 344 opposite to the bottom wall 342, so that the moving space 343 is able to communicate with the exterior via the second opening 344. The moving space 343 is defined for the propelling device 32 to be accommodated and moved therein, and the hydraulic oil 35 fills the moving space 343. Additionally, the propelling device 32 provides with an elastic member 321 disposed inside the moving space 343 and a propelling member 322 driven thereby. Part of the propelling member 322 is protruded out of the blocking device 33.

Referring to FIGS. 3 and 4, in fabricating the tension regulator 3, the propelling device 32 would be installed inside the pressure vessel 34; afterward, the moving space 343 would be filled up with the hydraulic oil 35. Accordingly, a complete fabrication of the product is preferably furnished by setting the pressure vessel 34 in the sliding space 311 of the body 31 and sealing the second opening 344 with the blocking device 33. Further, the pressure vessel 34 preferably adopts either a plastic material or an alloy material for being allowed to be bent; or an alloy steel material is directly processed to form the pressure vessel 34. Thereby, the pressure vessel 34 comprises a seamless formation. Herein this embodiment, the pressure vessel 34 adopts the alloy steel material that is directly processed to form the seamless contour thereof. Accordingly, in virtue of the seamless pressure vessel 34 installed in the body 31, the tension regulator 3 substantially prevents the hydraulic oil 35 in the moving space 343 from the outflow. While not in operation, namely the propelling member 322 stops thrusting against the timing belt, the hydraulic oil 35 would be blocked by the pressure vessel 34 for reducing the leakage. Even if the hydraulic oil 35 is compressed by the propelling member 322 to scatter around in the moving space 343 as a result of an increasing pressure while the propelling member 322 executes its thrusting action, the hydraulic oil 35 is still preferably retained in the moving space 343 of the seamless pressure vessel 34. Thus, the hydraulic oil 35 does not escape from interstices formed on the body 31 even if it is compressed, thereby ensuring the using safety. The tension regulator 3 also accomplishes a smooth operation.

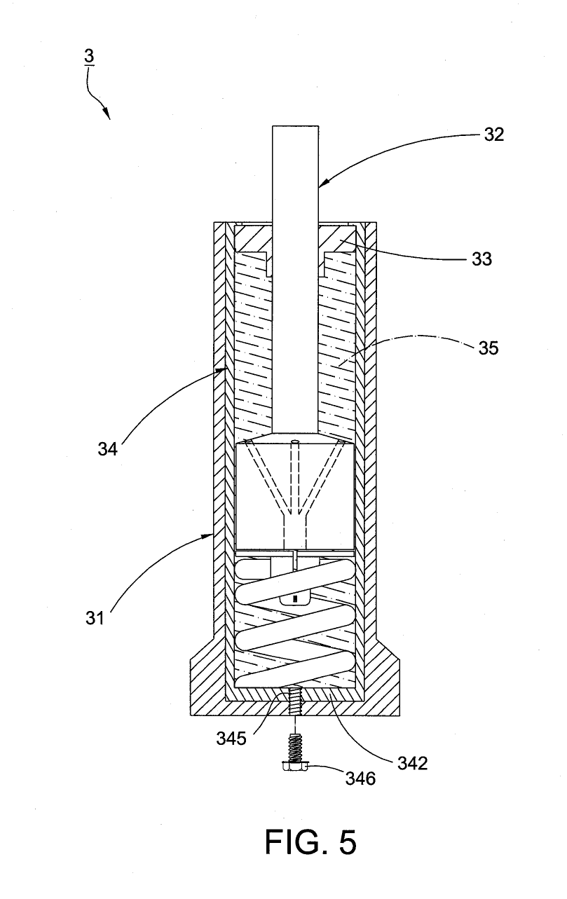

Referring to FIG. 5, a second preferred embodiment of the present invention is shown. The tension regulator 3 comprises the similar elements as those in the first preferred embodiment; namely, the tension regulator 3 substantially comprises a body 31, a propelling device 32, a blocking device 33, and a pressure vessel 34. The concatenation of associated elements and applications same to those of the first preferred embodiment are herein omitted. Differently, the pressure vessel 34 in this embodiment further defines a filling hole 345 on a bottom wall 342 thereof for penetrating through the body 31 and communicating with the exterior; wherein, the filling hole 345 is sealed by a blocking member 346. Accordingly, if the pressure vessel 34 contains insufficient hydraulic oil 35, the blocking member 346 will be timely removed for users to swiftly replenish the oil through the filling hole 345, thereby guaranteeing the tension regulator 3 to constantly maintain an adequate amount of hydraulic oil 35.

To sum up, the present invention takes advantage of the pressure vessel to be formed between the body and the propelling device for averting the hydraulic oil from seeping, thereby achieving the object of the present invention.

While we have shown and described the embodiment in accordance with the present invention, it should be clear to those skilled in the art that further embodiments may be made without departing from the scope of the present invention.

What is claimed is:

1. A tension regulator with a pressure vessel applied to a timing belt comprising a body filled with hydraulic oil, a propelling device installed in said body, and a blocking device disposed for sealing said body and limiting said propelling device in said body; wherein, said body including a sliding space one side thereof communicated with an exterior via a first opening defined thereon; said first opening being sealed by said blocking device; said propelling device including an elastic member and a propelling member driven by said elastic member; a part of said propelling member being protruded out of said blocking device;
characterized in that a pressure vessel mounted between said body and said propelling device including a moving space enveloped by a circumferential wall and a bottom wall; said pressure vessel further forming a second opening opposite to said bottom wall, thereby permitting said moving space to communicate with said exterior via said second opening; said moving space being defined for said propelling device to be accommodated and moved therein, and said moving space being filled up with said hydraulic oil.

2. The tension regulator as claimed in claim 1, wherein said bottom wall defines a filling hole that penetrates through said body and communicates with said exterior, and a sealing member is disposed on said filling hole for sealing.
